(19) United States
(12) Patent Application Publication
(10) Pub. No.: US 2013/0054319 A1
(43) Pub. Date: Feb. 28, 2013

(54) METHODS AND SYSTEMS FOR PRESENTING A THREE-DIMENSIONAL MEDIA GUIDANCE APPLICATION

(71) Applicants: Thomas Steven Woods, Arlington Heights, IL (US); William J. Korbecki, Crystal Lake, IL (US); Melvin Grefalda, Chicago, IL (US); Adam Powers, Dublin, CA (US)

(72) Inventors: Thomas Steven Woods, Arlington Heights, IL (US); William J. Korbecki, Crystal Lake, IL (US); Melvin Grefalda, Chicago, IL (US); Adam Powers, Dublin, CA (US)

(73) Assignee: United Video Properties, Inc., Santa Clara, CA (US)

(21) Appl. No.: 13/341,141

(22) Filed: Dec. 30, 2011

Related U.S. Application Data
(60) Provisional application No. 61/528,446, filed on Aug. 29, 2011.

(51) Int. Cl. G06F 3/048; G06Q 30/02

(52) U.S. Cl. 705/14.4; 715/848

(57) ABSTRACT

Methods and systems can generate a stereoscopic three-dimensional, virtual environment for presentation on a display. This virtual environment may include representations of a plurality of buildings, wherein each of the plurality of buildings represents a different characteristic of content and/or content listings. The virtual environment can be presented from a first point of view to a user. In response to user input, the presentation of the virtual environment can be changed from the first point of view to a second point of view. The rate at which the presentation of the virtual environment is changed can be controlled based on a distance between the first point of view and the second point of view. A user selection of one of the plurality of buildings can be received, and options can be presented which are associated with the characteristic represented by the building selected by the user.

### CROSS REFERENCE TO RELATED APPLICATION

This application claims the benefit of U.S. Provisional Patent Application No. 61/528,446, filed Aug. 29, 2011, which is hereby incorporated by reference herein in its entirety.

### BACKGROUND OF THE INVENTION

With the continuous improvement in graphic processing capabilities of televisions, set-top boxes, audio-video equipment, computers, and other media devices, there is an increasing demand to present media guidance applications which take advantage of these capabilities. For example, media devices with traditional two-dimensional display capabilities continue to improve in their capability to render complex graphic images. As another example, media devices with three-dimensional display capabilities demonstrate an even greater ability to render complex graphic images. However, current media guidance applications do not adequately utilize such capabilities.

### SUMMARY OF THE INVENTION

In view of the foregoing, methods and systems for presenting a three-dimensional media guidance application are provided. In particular, in some embodiments, these methods and systems can generate a stereoscopic three-dimensional, virtual environment for presentation on a display. This virtual environment may include representations of a plurality of buildings, wherein each of the plurality of buildings represents a different characteristic of content and/or content listings. The virtual environment can be presented from a first point of view to a user. In response to user input, the presentation of the virtual environment can be changed from the first point of view to a second point of view. The rate at which the presentation of the virtual environment is changed can be controlled based on a distance between the first point of view and the second point of view. A user selection of one of the plurality of buildings can be received, and options can be presented which are associated with the characteristic represented by the building selected by the user.

In some embodiments, the rate at which the presentation of the virtual environment is changed can also be controlled based on a rotation between the first point of view and the second point of view.

In some embodiments, the virtual environment can include an advertisement.

In some embodiments, the advertisement can be represented as a billboard.

In some embodiments, the advertisement can be represented as a store of the advertiser.

In some embodiments, the building selected can be a building associated with movies, and the options presented can be content and/or content listings associated with movies.

In some embodiments, the virtual environment can include a translucent panel showing video.

In some embodiments, the virtual environment can include an indicator of current weather in an area of the user.

In some embodiments, content presented on a face of one of the plurality of buildings can be changed to correspond to a real event.

In some embodiments, a content listing can be presented on a face of one of the plurality of buildings.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments of the invention;

FIG. 3 shows an illustrative user equipment device in accordance with some embodiments of the invention;

FIG. 4 is a diagram of an illustrative cross-platform interactive media system in accordance with some embodiments of the invention;

FIG. 5 shows an illustrative user interface for configuring a three-dimensional (3D) environment for a media guidance application in accordance with some embodiments of the invention.

FIG. 6 shows an illustrative user interface of a three-dimensional (3D) environment for a media guidance application in accordance with some embodiments of the invention.

FIGS. 7-8 show illustrations of transitions in a change in point of view in the 3D environment of FIG. 6 from the point of view in FIG. 6 to the point of view in FIG. 9 in accordance with some embodiments of the invention.

FIG. 9 shows an example of a movie category, theme, or other characteristic building in accordance with some embodiments of the invention.

FIG. 10 shows an example of a process for transitioning between points of view in the 3D environment of FIGS. 6-9 in accordance with some embodiments of the invention.

FIG. 11 shows examples of content and/or content listings that may be presented in connection with a movie category, theme, or other characteristic building in accordance with some embodiments of the invention.

FIG. 12 shows an example of a process for presenting a three-dimensional (3D) environment for a media guidance application in accordance with some embodiments of the invention.

FIG. 13 shows an example of a financial category, theme, or other characteristic building in the 3D environment as viewed from the point of view of FIG. 6 in accordance with some embodiments of the invention.

FIG. 14 shows an example of a financial category, theme, or other characteristic building in the 3D environment as viewed from another point of view in accordance with some embodiments of the invention.

FIG. 15 shows examples of content and/or content listings that may be presented in connection with a financial category, theme, or other characteristic building in accordance with some embodiments of the invention.

FIG. 16 shows an example of a music category, theme, or other characteristic building in accordance with some embodiments of the invention.

FIG. 17 shows examples of content and/or content listings that may be presented in connection with a music category, theme, or other characteristic building in accordance with some embodiments of the invention.

FIG. 18 shows an example of an advertisement as presented in the form of a building/store sign in accordance with some embodiments of the invention.

FIG. 19 shows another example of an advertisement as presented in the form of a building/store sign in accordance with some embodiments of the invention.

FIG. 20 shows an example of a menu interface that may be presented when the building of FIG. 19 is selected in accordance with some embodiments of the invention.

FIGS. 21-22 show examples of user interfaces for presenting weather information in a 3D environment in accordance with some embodiments of the invention.

FIG. 23 shows an example of a search interface in accordance with some embodiments of the invention.

FIG. 24 shows an example of a preview window in accordance with some embodiments of the invention.

FIG. 25 shows an example of an interface for presenting content and/or content listings as if on a cylindrical wall in accordance with some embodiments of the invention.

FIG. 26 shows an example of a user interface for presenting additional content listing information for a listing presented in FIG. 25 in accordance with some embodiments of the invention.

FIG. 27 shows an example of presenting content and/or content listings as floating panels in front of a cityscape background in accordance with some embodiments of the invention.

FIG. 28 shows an example of presenting menu options as floating icons in front of a mountain range background in accordance with some embodiments of the invention.

FIG. 29 shows an example of an XML structure for a query in accordance with some embodiments of the invention.

FIG. 30 shows an example of an XML structure for a query response in accordance with some embodiments of the invention.

### DETAILED DESCRIPTION OF EMBODIMENTS

The invention generally relates to methods and systems for presenting a three-dimensional media guidance application. In particular, in some embodiments, these methods and systems can generate a stereoscopic three-dimensional, virtual environment for presentation on a display. This virtual environment may include representations of a plurality of buildings, wherein each of the plurality of buildings represents a different characteristic of content and/or content listings. The virtual environment can be presented from a first point of view to a user. In response to user input, the presentation of the virtual environment can be changed from the first point of view to a second point of view. The rate at which the presentation of the virtual environment is changed can be controlled based on a distance between the first point of view and the second point of view. A user selection of one of the plurality of buildings can be received, and options can be presented which are associated with the characteristic represented by the building selected by the user.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

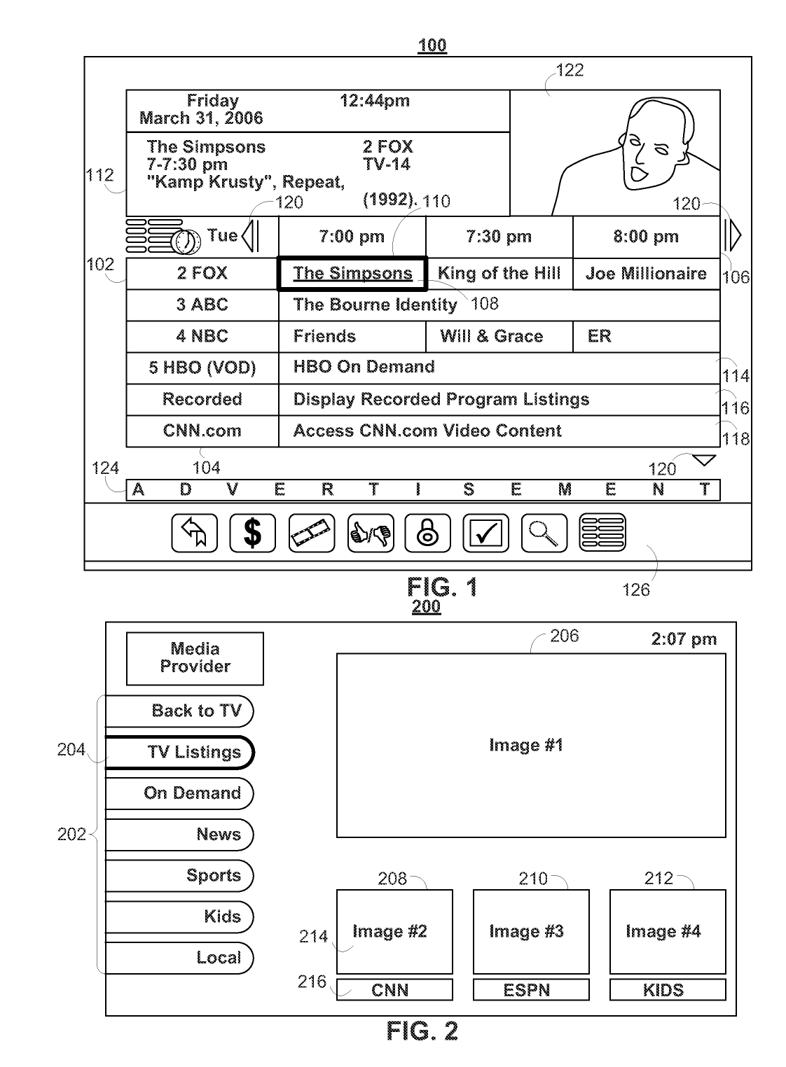

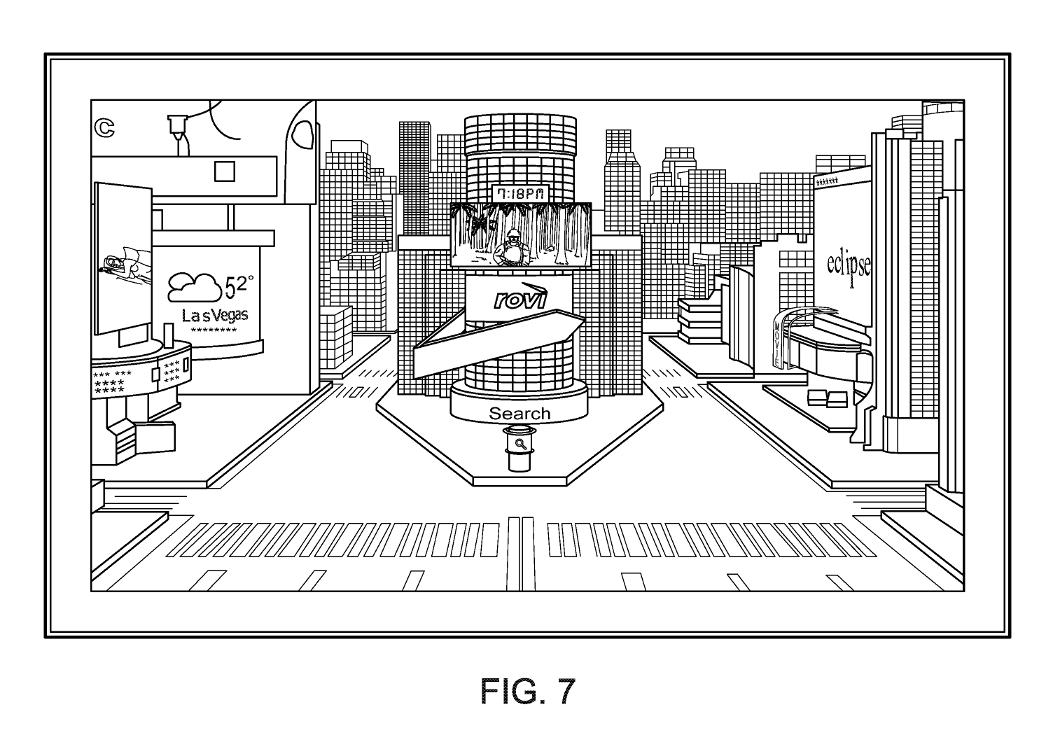

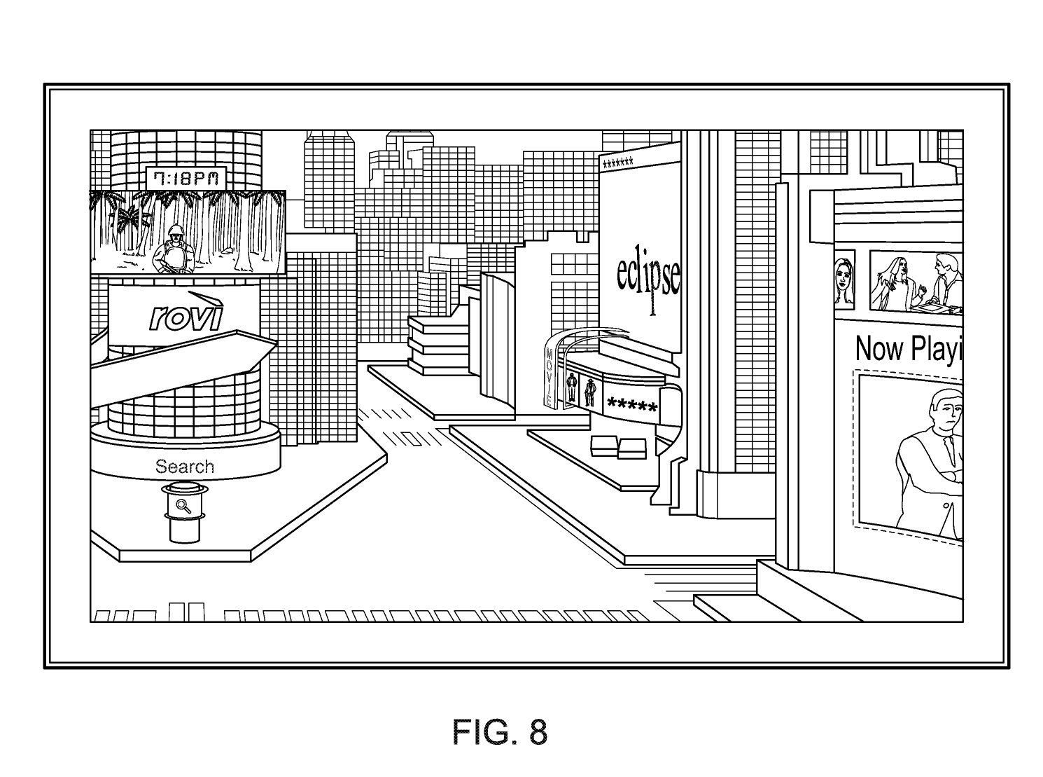

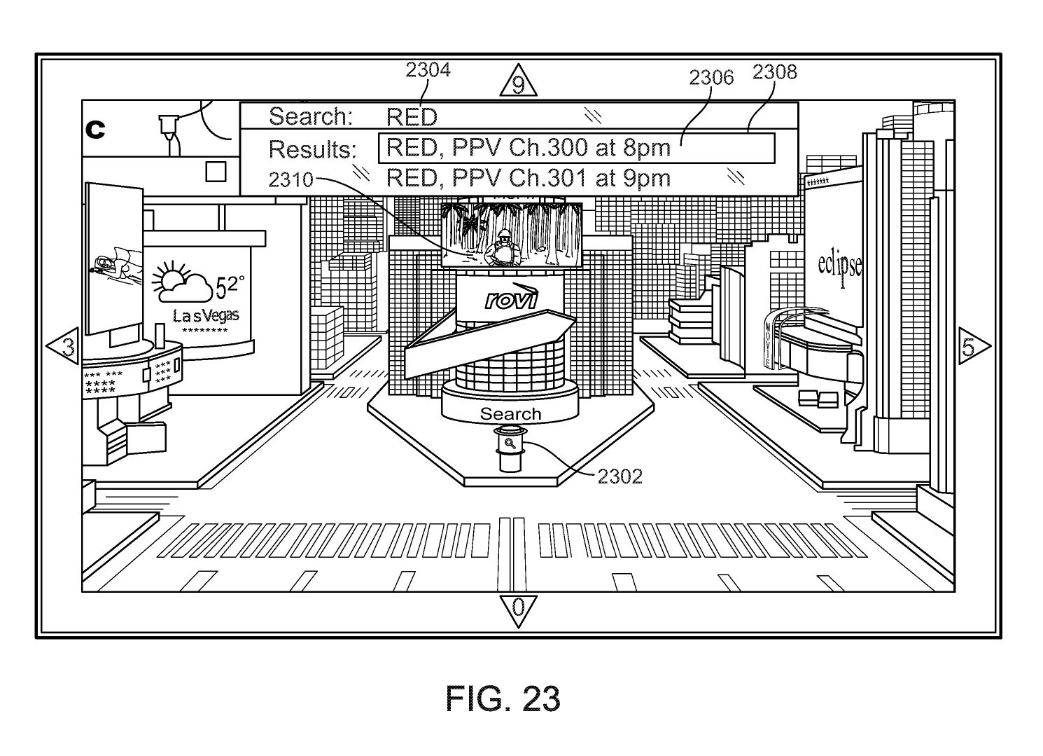

FIGS. 1-2 show illustrative display screens that may be used to provide media guidance data. The display screens shown in FIGS. 1-2, 5-9, 11 and 13-28 may be implemented on any suitable user equipment device or platform. While the displays of FIGS. 1-2, 5-9, 11 and 13-28 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or a guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

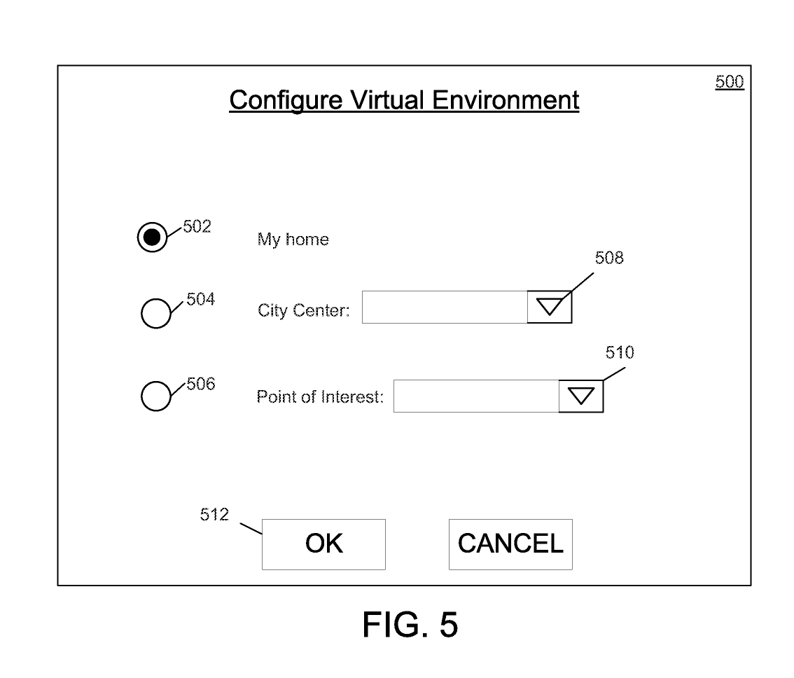

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

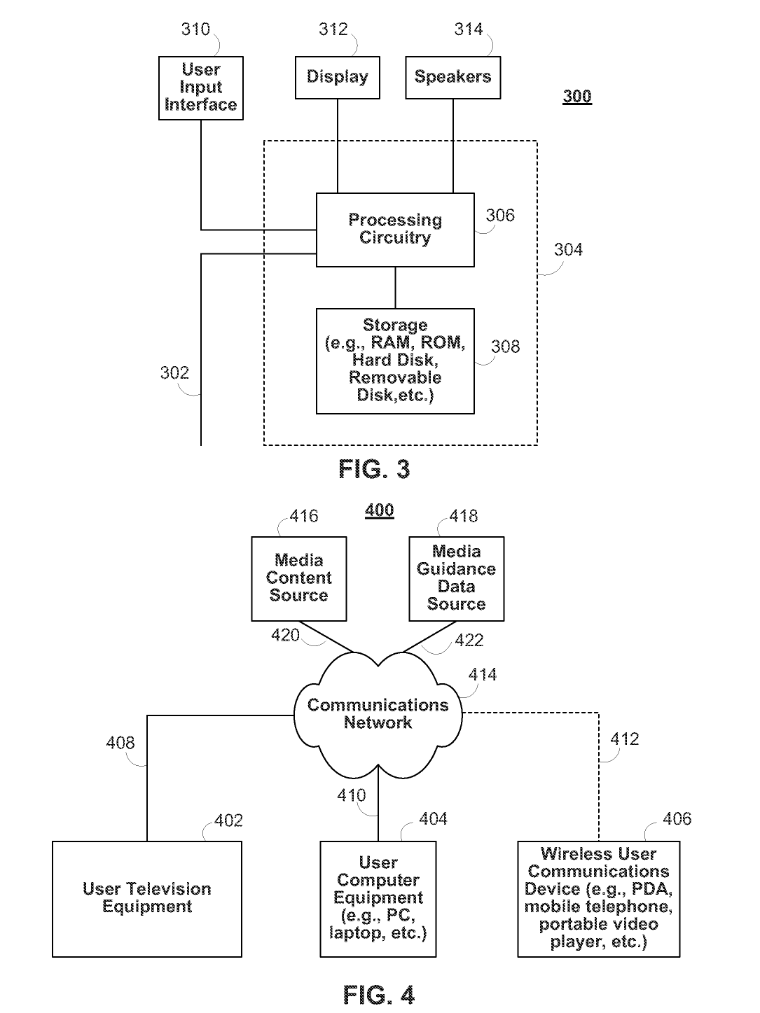

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or a supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized hardware processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using any other suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412.

Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and a server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

In accordance with some embodiments, a media guidance application can be presented as a three-dimensional (3D), virtual environment in which different portions of the environment correspond to different categories, themes, or other characteristics of content and/or content listings.

For example, in some embodiments, a 3D, virtual environment can be a 3D, virtual replica of Times Square in New York, N.Y.. In this environment, different buildings can represent different categories, themes, or other characteristics of content and/or content listings, such as music content for a music hall, movie content listings for a movie theatre, video-on-demand content for a video-on-demand building, financial content listings for a stock market building, etc.

In another example, in some embodiments, a 3D, virtual environment can be a virtual replica of a user's home. In this environment, different rooms can represent different categories, themes, or other characteristics of content and/or content listings, such a family content for a family room, music and/or music video content listings for a teen's bedroom, sports content for a game room, financial content listings for an office, etc.

In yet another example, in some embodiments, a 3D, virtual environment can be a virtual replica of a library (or a portion of a library). More particularly, for instance, in such an environment, aisles or rows of shelves may be presented. A label, sign, or other suitable indicator at the end of each aisle or row (or a group of aisles or rows) may identify a category, theme, or other characteristic associated with content and/or content listings presented on corresponding shelves of the aisle or row (or group). Upon selecting an aisle or row, the user may be presented with content and/or content listings presented as items on one or more shelves. These items may be presented in any suitable manner. For example, these items may be presented as DVD cases, books, CD cases, records, movie reels, and/or any other suitable physical representation of content. These items may be ordered in any suitable manner. For example, these items may be ordered alphabetically, by release date, by a sub-category, by a main performer, and/or by any other suitable characteristic. Certain content and/or content listings can be presented in manner that makes the content and/or content listings stand out from other content and/or content listings. For example, some content and/or content listings can be presented on a dedicated shelf, an end of an aisle or row, a library table, etc. Advertising can also be facilitated in such an environment. For example, an advertisement may be presented with a sign that indicates that “This aisle of the library is sponsored by . . . ” as may be found in real-world library. Of course, any suitable variations can be made in some embodiments.

Any suitable real and/or fictitious place, or a combination of the same, can be used as a basis for such an environment in some embodiments.

Turning to FIG. 5, an example of a user interface 500 for configuring such a 3D, virtual environment in accordance with some embodiments is shown. As illustrated, a user can select one of radio buttons 502, 504, or 506 to select whether the environment is to be based on the user's home, a city center, or a point of interest, respectively. Upon selecting to base the environment on a city center, the user may select a particular city center or a “pick for me” option from a drop-down menu 508. The contents of menu 508 can be arranged in any suitable order, such as alphabetically, based on the places the user has visited most recently, etc. Upon selecting to base the environment on a point of interest, the user may select the particular point of interest or a “pick for me” option from a drop-down menu 510. The contents of menu 510 can be arranged in any suitable order, such as geographically, alphabetically, etc. Once a user has finished his/her selection, the user can press an OK button 512. In response to such selections, control circuitry 304 in a user equipment device 300 can configure the environment for presentation.

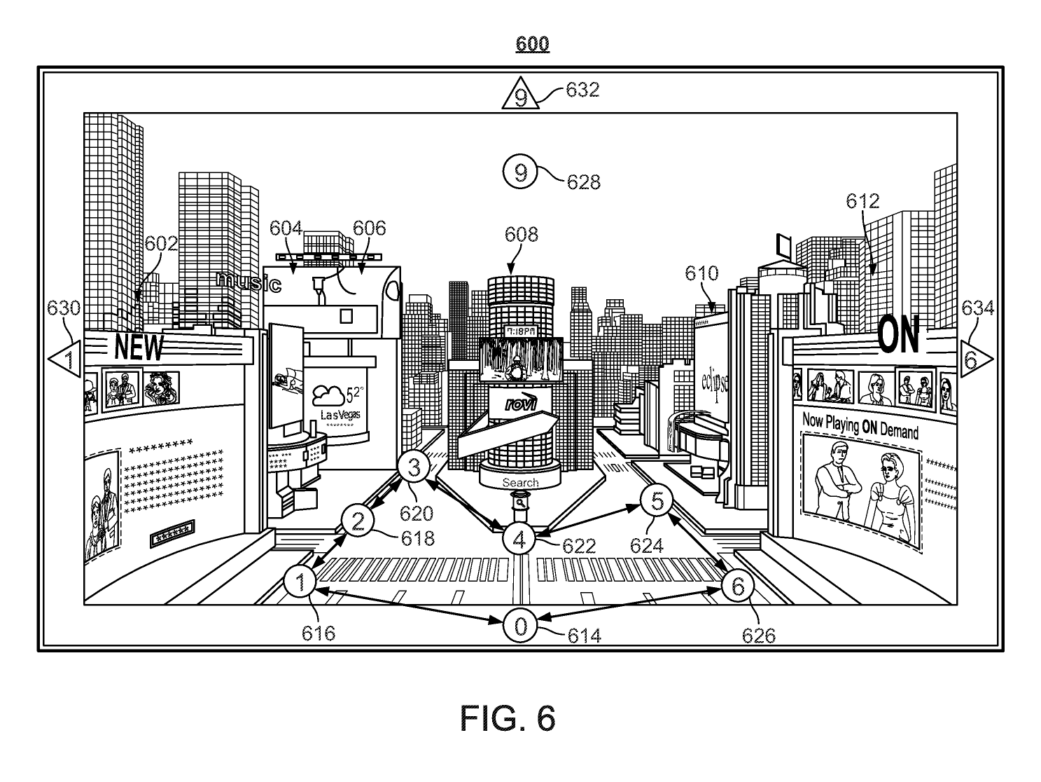

Turning to FIG. 6, an example of a 3D, virtual environment 600 based on Times Square that can be presented by the control circuitry in response to user selections is shown.

As illustrated in FIG. 6, multiple buildings 602, 604, 606, 608, 610, and 612 can be provided in this 3D environment and at least some of these buildings can be associated with certain categories, themes or other characteristics of content and/or content listings. For example, as shown, a building 602 can be associated with new content and/or content listings, a building 604 can be associated with music content and/or content listings, a building 606 can be associated with weather content and/or content listings, a building 608 can be associated with searchable content and/or content listings, a building 610 can be associated with movie content and/or content listings, and a building can be associated with on-demand content and/or content listings. In some embodiments, any other suitable types of buildings, and any suitable number of buildings, can additionally or alternatively be provided in a 3D environment.

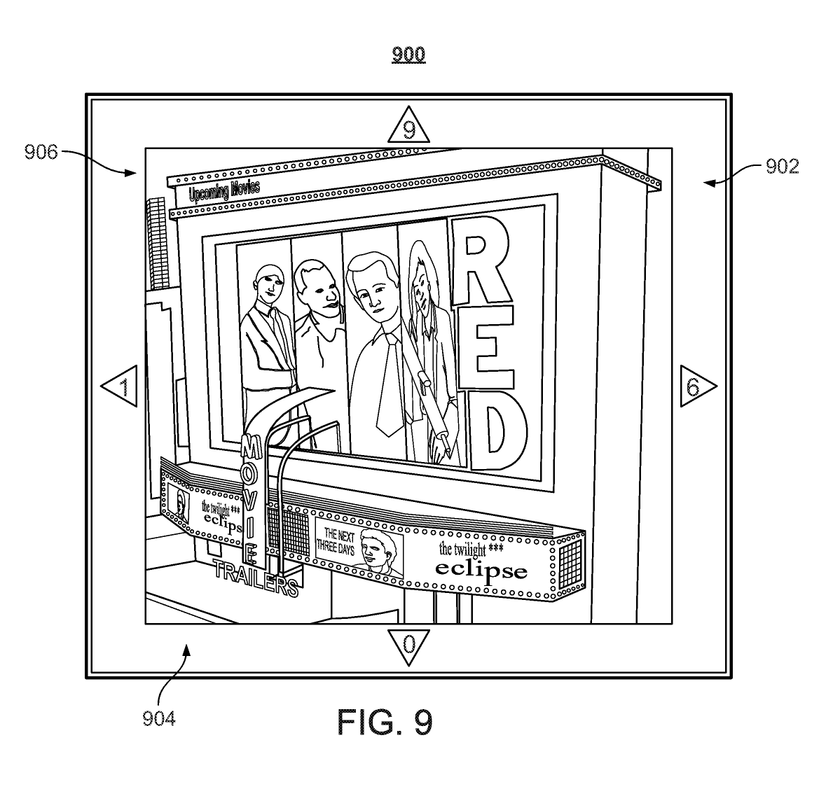

In some embodiments, a user can cause control circuitry 304 to change the point of view presented so as to give the impression that the user is moving around in the 3D environment. For example, as shown in FIG. 9, a user can cause control circuitry 304 to change his or her point of view so as to appear to be in front of a movie theatre building.

In some embodiments, control circuitry 304 may be able to present any suitable number of points of view (including an infinite number) in the 3D environment. For example, in some embodiments, as shown in FIG. 6, control circuitry 304 may be able to present eight points of view as follows: (1) the view shown in FIG. 6 from point 614; (2) the view looking leftward from point 1 616 in FIG. 6; (3) the view looking leftward from point 2 618 in FIG. 6; (4) the view looking leftward from point 3 620 in FIG. 6; (5) the view looking straight ahead (i.e., into the figure) from point 4 622 in FIG. 6; (6) the view looking rightward from point 5 624 in FIG. 6; (7) the view looking rightward from point 6 626 in FIG. 6; and (8) the view of looking toward the sky at point 9 628 in FIG. 6.

In some embodiments, a user can use hand gestures to cause the control circuitry to change the point of view presented. Such hand gestures can be received in any suitable manner. For example, hand gestures can be detected and provided to control circuitry 304 by a user input interface having accelerometers that is held in a user's hand while making a gesture. As another example, hand gestures can be detected and provided to control circuitry 304 by a user input interface having an optical sensor that detects a user's hand gestures optically.

In some embodiments, additionally or alternatively to using gestures, a user can press arrow buttons on a user input interface 310 of user equipment device 300 to cause control circuitry 304 to change the point of view in environment 600. More particularly, in some embodiments, to change the point of view presented by control circuitry 304, a user can press a left arrow button, a right arrow button, or an up arrow button as indicated by icons 630, 634, and 632, respectively. As indicated by the “1” in icon 630, upon receiving a depression of the left arrow button when the point of view from point 0 614 is being presented, control circuitry 304 can transition to presenting the point of view of point 1 616. Similarly, as indicated by the “6” in icon 634, upon receiving a depression of the right arrow button when the point of view from point 0 614 is being presented, control circuitry 304 can transition to presenting the point of view of point 6 626. Also, as indicated by the “9” in icon 632, upon receiving a depression of the up arrow button, the control circuitry can transition to presenting the point of view facing point 9 628.

In some embodiments, additionally or alternatively to using gestures and/or pressing arrow buttons, a user can press a number button on a user input interface 310 to cause control circuitry 304 to change the point of view presented. For example, to see the point of view from point 1 616, a user can press the “1” button. Likewise, as another example, to see the point of view from point 2 618, a user can press the “2” button.

In some embodiments, after a user makes an input to change the point of view in environment 600, the control circuitry 304 can pan, tilt, and/or zoom (or un-zoom) the image presented to the user so that it transitions from one point of view to another. For example, if the user indicates to switch to the point of view from point 5 524 looking rightward while the control circuitry 304 is presenting the point of view from point 0 614 as shown in FIG. 6, the control circuitry can transition the point of view to that from point 5 as illustrated by the transitional steps shown in FIGS. 6, 7, 8, and 9 for example. Of course, in some embodiments, the transition from the view shown in FIG. 6 to the view shown in FIG. 9 can be a smooth natural transition as if the user was moving through environment 600.

In order to provide a natural-feeling transition, the rate at which the point of view in environment 600 is changed may be controlled by control circuitry 304. For example, in some embodiments, this rate can be set based upon the virtual distance to be travelled and/or the amount of virtual rotation required when transitioning from one point of view to another.

For example, in some embodiments, transition times for different Euclidian distances and rotations can be as set forth in the following table:

| | Euclidian | Rotation (X, Y, Z) | Transition |
|---|---|---|---|
| Transition # | Distance | (degrees) | Time (seconds) |
| 1 | 18.7 | (−6, −57, 0) | 1.0 |
| 2 | 51.0 | (−10, −89, 0) | 1.0 |
| 3 | 46.4 | (−10, −89, 0) | 1.0 |
| 4 | 55.2 | (0, 0, 0) | 1.9 |
| 5 | 49.3 | (−5, 56, 0) | 1.0 |
| 6 | 46.5 | (−10, 78, 0) | 1.5 |
| 7 | 18.4 | (1, 57, 0) | 1.0 |
| 8 | 52.6 | (0, 0, 0) | 1.9 |
| 9 | 42.3 | (0, 0, 0) | 1.9 |

Although particular examples of transition times for particular transitions are provided above, these are just examples of different transition times based on different distances and rotations that can be used in some embodiments. Any suitable transition times can be used in some embodiments.

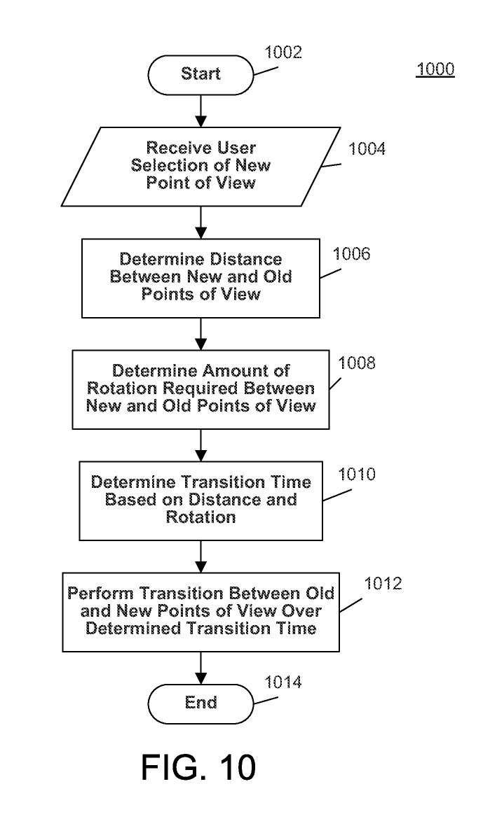

FIG. 10 illustrates an example of a process 1000 for controlling transitions that can be used by control circuitry 304 of a user equipment device 300 in some embodiments.

As shown, after process 1000 begins at 1002, control circuitry 304 can receive at 1004 a user selection of a new point of view to be presented in a media guidance application presenting a 3D environment. This selection can be received in any suitable manner as described above.

Next, at 1006, the control circuitry can determine a distance between the new point of view and the old (or previous) point of view. This determination can be made in any suitable manner in some embodiments. For example, where the points of view available for selection by a user are limited to a predefined set of points of view, a predefined table providing a distance between each point of view can be queried by control circuitry 304. Such a table can take into account any desired transition paths between the two points. In some embodiments, such a table can be stored in a database in storage 308. As another example, where the points of view available for selection are not predefined and/or limited, the distance between the new point of view and the old point of view based on any suitable coordinate system can be calculated.

At 1008, the amount of rotation between the new point of view and the old (or previous) point of view can be determined by the control circuitry. This determination can be made in any suitable manner in some embodiments. For example, where the points of view available for selection by a user are limited to a predefined set of points of view, a predefined table providing an amount of rotation between each point of view can be queried by control circuitry 304. Such a table can take into account any desired transition paths between the two points. In some embodiments, such a table can be stored in a database in storage 308, and a single table showing the distances and rotations for different transitions can be utilized. As another example, where the points of view available for selection are not predefined and/or limited, the amount of rotation between the new point of view and the old point of view based on any suitable coordinate system can be calculated.

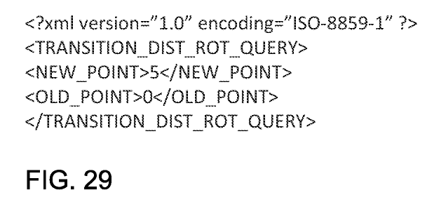

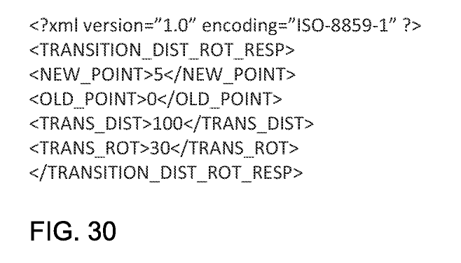

In some embodiments, for example, steps 1006 and 1008 can be combined into a single step and that step can be performed by making a single query to any suitable table, storage device, database, etc. and by retrieving distance and rotation values from the query's response. Such a query and such a response can be made using XML structures as illustrated in FIGS. 29-30, in some embodiments.

Based on the determined distance and the determined rotation, the transition time between the two points of view can be determined by control circuitry 304 at 1010. This determination can be made in any suitable manner in some embodiments. For example, in some embodiments, the transition time can be calculated based on the table above by using the transition time that corresponds to the most-similar combination of distance and rotation. In some embodiments, these transition times may be limited to be a minimum of one second (or any other suitable value) and a maximum of two seconds (or any other suitable value). In some embodiments, the transition times can be adjusted to take into account personal preferences of the user. For example, some users may configure the transition to occur more slowly whereas other users may configure the transition to happen more quickly. Such personal preferences can be obtained from any suitable settings, preference, and/or profile of the user.

Once the transition time has been determined, the control circuitry can perform the transition between the old (or previous) point of view and the new point of view at 1012. This transition can be performed in any suitable manner. For example, this transition can be performed as described above in connection with FIGS. 6-9. In some embodiments, during the transition, an object in the new point of view can be used as a focal point during the transition. For example, the movie theatre building can be used as a focal point in the transition shown in FIGS. 6-9. Once the transition has completed, process 1000 can terminate at 1014.

It should be understood that the above steps of the flow diagram of FIG. 10 may be executed or performed in any order or sequence not limited to the order and sequence shown and described in the figure. Also, some of the above steps of the flow diagram of FIG. 10 may be executed or performed substantially simultaneously where appropriate or in parallel to reduce latency and processing times.

Referring back to FIG. 9, as shown, once the user's point of view has been transitioned, a user may more closely see the details of the outside of a virtual building 902 in 3D environment 600. As also shown in FIG. 9, the outside of a building can be configured to correspond to a category, theme, or other characteristic of content and/or content listings. For example as shown in FIG. 9, a building can be configured to look like a common movie theatre so as to correspond to movie content and movie content listings. As illustrated, a building may additionally or alternatively be labeled so as to correspond to a category, theme, or other characteristic of content and/or content listings. For example, “movie trailers” label 904 and “upcoming movies” labels 906 may be provided to show that the building corresponds to movie content and movie content listings. The outside of the building may additionally or alternatively display content and/or content listings that correspond to a category, theme, or other characteristic of content and/or content listings. For example, as shown in FIG. 9, the outside of a movie theatre building may include content and/or content listings corresponding to movies such as “RED”, “THE NEXT THREE DAYS”, and “THE TWILIGHT SAGA ECLIPSE”. Any other suitable way of associating a building with a category, theme, or other characteristic of content and/or content listings can be used in some embodiments.

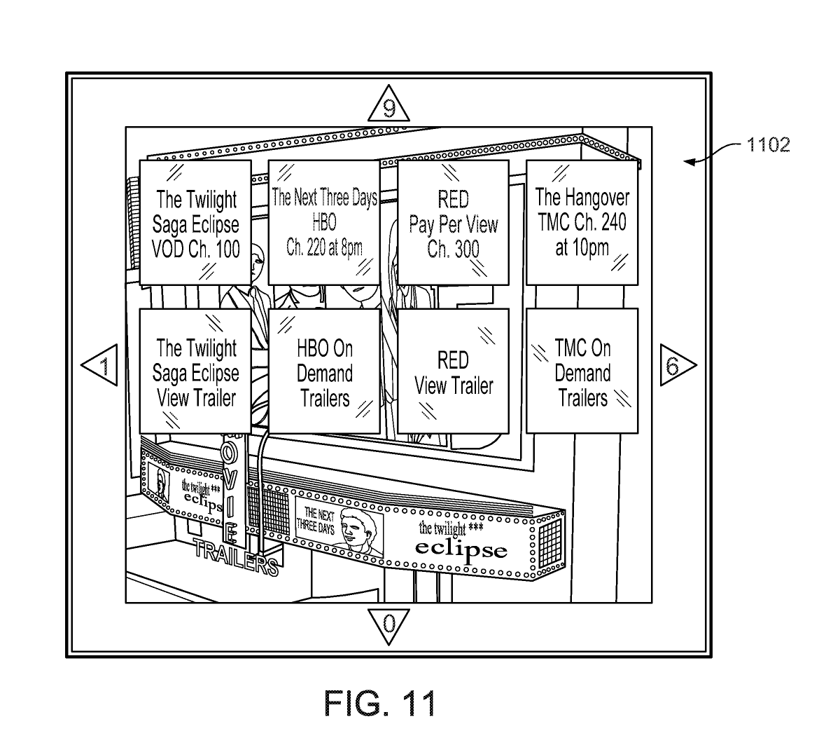

In some embodiments, once at a point of view facing a building, a user may be presented with content and/or content listings corresponding to the category, theme, or other characteristic associated with the building by the control circuitry. For example, with the movie theatre building of FIG. 9, once at point of view 5 624 (FIG. 6), a user may be able to view content and/or content listing corresponding to the category, theme, or other characteristic of the building. As a more particular example, once at point of view 5 624 (FIG. 6), in response to receiving a user selecting a building using a user input interface, the control circuitry may present content listings 1102 corresponding to the category, theme, or other characteristic of the building as illustrated in FIG. 11. As shown, content listings 1102 may present content listings for content indicated on the outside of the building and/or may present content listings for content not indicated on the outside of the building. Any suitable content and/or content listings may be presented by the control circuitry in some embodiments. In response to a user selecting one or more of these content listings, the control circuitry may then present more information about the content listing, present the content corresponding to the content listing, set up to record the content corresponding to the content listing, set up a reminder to watch the content listing, and/or perform any other suitable operation as described herein.

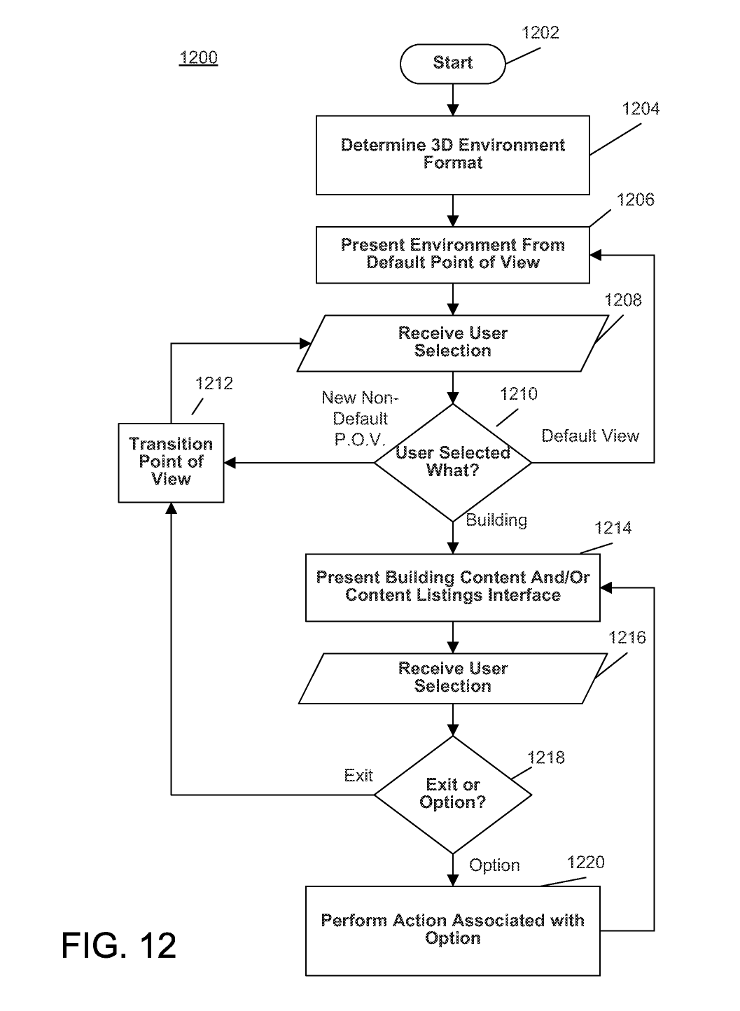

An example of a process 1200 for presenting a 3D virtual environment that can be performed by control circuitry 304 in accordance with some embodiments is shown in FIG. 12. As illustrated, after process 1200 begins at 1202, the control circuitry can first determine the form of the 3D environment at 1204. This can be performed in any suitable manner such as by using user interface 400 of FIG. 4, retrieving information from a profile of a user stored in storage 308, etc.

Next, the environment can be presented from a default point of view at 1206. This environment can be presented in any suitable manner. For example, in some embodiments, this environment can be presented as illustrated in FIG. 6. Then, at 1208, the control circuitry can receive a user selection via a user input interface. As described above, this selection can be made in any suitable manner, such as by using gestures, pressing arrow buttons, pressing number buttons, etc.

At 1210, the control circuitry can then determine what the user selected. If it is determined that the user selected to view a new non-default point of view, then the control circuitry can transition to that point of view at 1212 as described above in connection with FIG. 10. If it is determined that the user selected to view the default point of view, then the control circuitry can loop back to 1206. If it is determined at 1210 that the user selected a building, then process can continue to 1214.

At 1214, the control circuitry can present content and/or content listings associated with a building. This can be performed in any suitable manner. For example, in some embodiments, the control circuitry can retrieve options configuration data from a database in storage 308 for the selected building. Then, the control circuitry can use this data to determine where options should be presented, to determine what should be displayed for each option, to determine what action should be taken in response to each option be selected, etc. Finally, control circuitry 304 can present the options.

Next, the control circuitry can receive a user selection at 1216 and determine whether the selection was an exit selection or an option selection. If the selection is determined to be an exit selection, then the process can loop back to 1212. Otherwise, the process can continue to 1220 at which the control circuitry can perform an action based on the options configuration data retrieved at 1214 and then loop back to 1214.

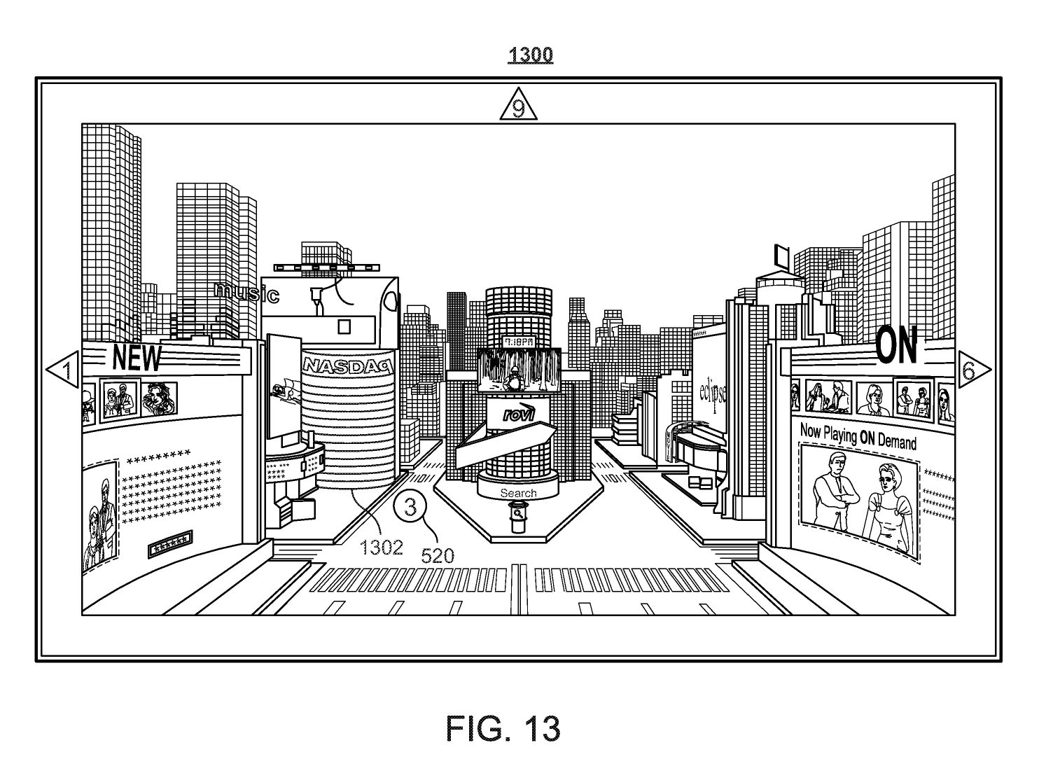

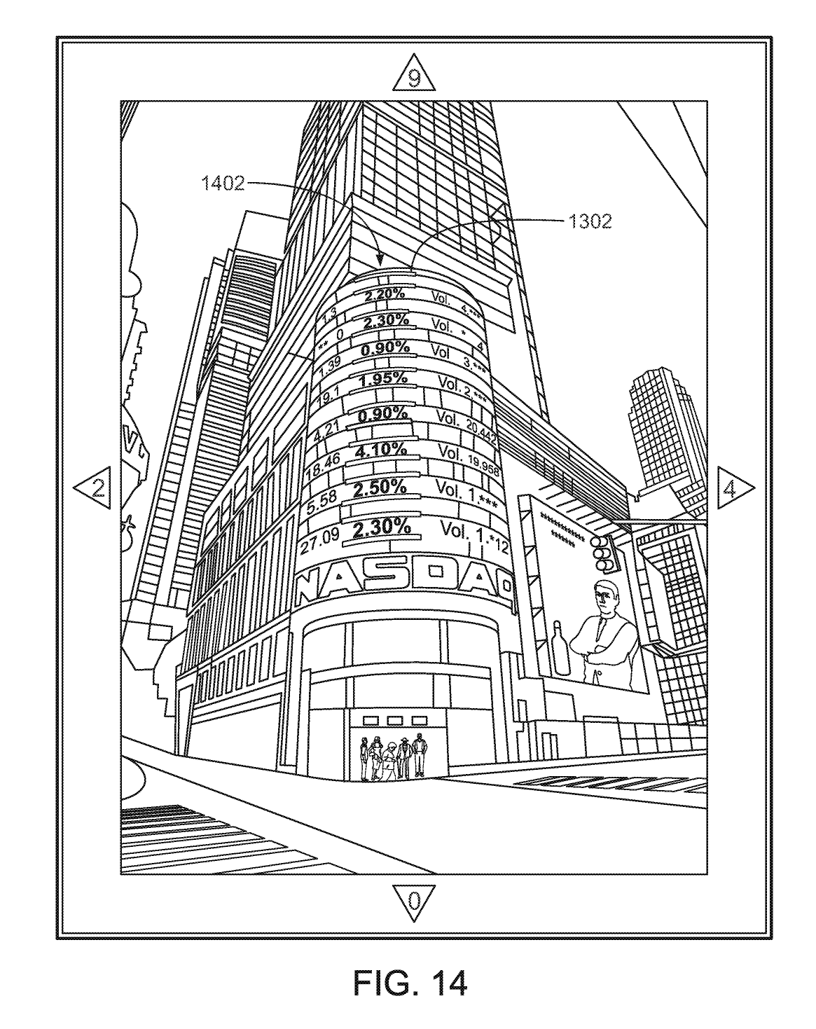

As shown in FIG. 13 in accordance with some embodiments, a 3D environment 1300 can include a building 1302 related to financial content and/or financial content listings. In response to receiving a user depression of a “9” button on a user input interface, the control circuitry may transition the point of view to point 3 620 as shown in FIG. 14. As illustrated, building 1302 can display financial data 1402 on the outside of the building (which financial data can be updated in real time in some embodiments) as well as show the name of the “NASDAQ” exchange to reflect that the category, theme, or other characteristic associated with the building is financial content and/or financial content listings.

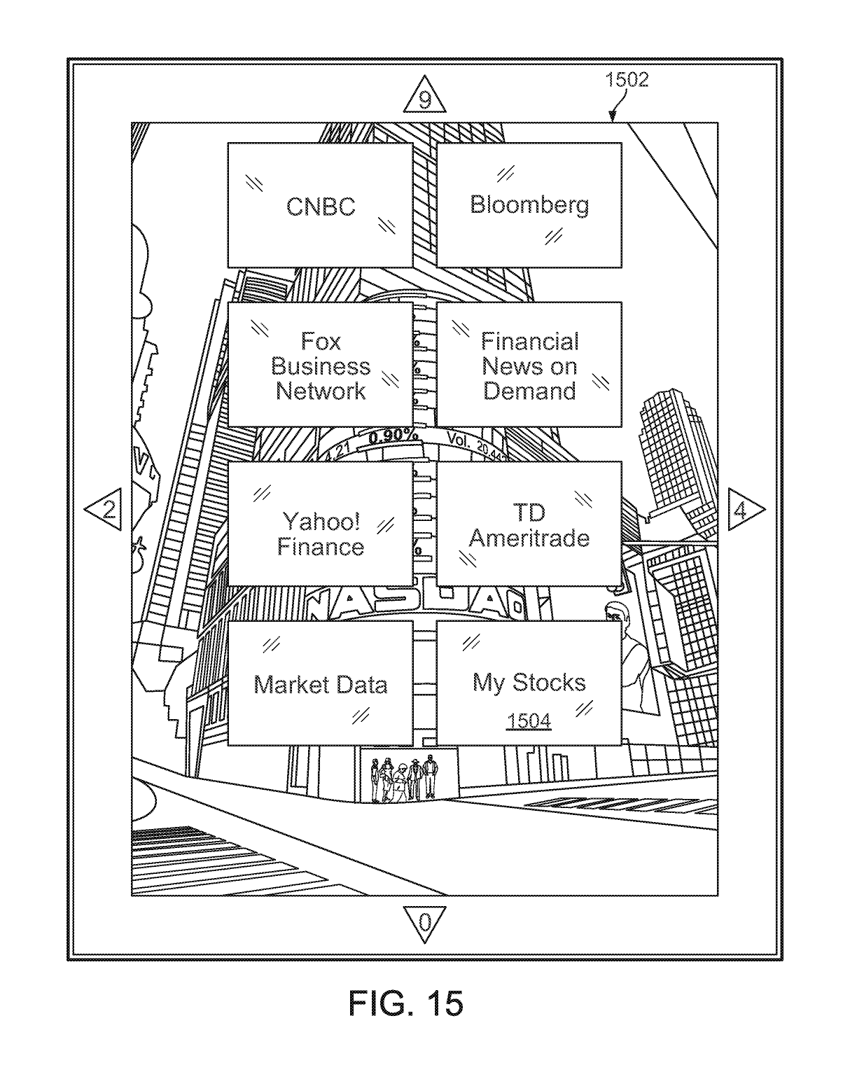

In response to a user selecting the building, financial related content and/or content listings may be presented by the control circuitry as illustrated in FIG. 15. Any suitable content and/or content listings may be presented by the control circuitry in some embodiments. In response to a user selecting one or more of these content listings, the control circuitry may then present more information about the content listing, present the content corresponding to the content listing, set up to record the content corresponding to the content listing, set up a reminder to watch the content listing, and/or perform any other suitable operation as described herein.

For example, in some embodiments, in response to a user selecting content listing 1504, control circuitry 304 may retrieve a user profile of the user, determine securities held by or on a watch list of a user, present quotes for trades in those securities, configure those quotes to be presented and updated with financial data 1402 (FIG. 14), provide an interface through which the user can execute trades in those securities, and/or perform any other suitable function.

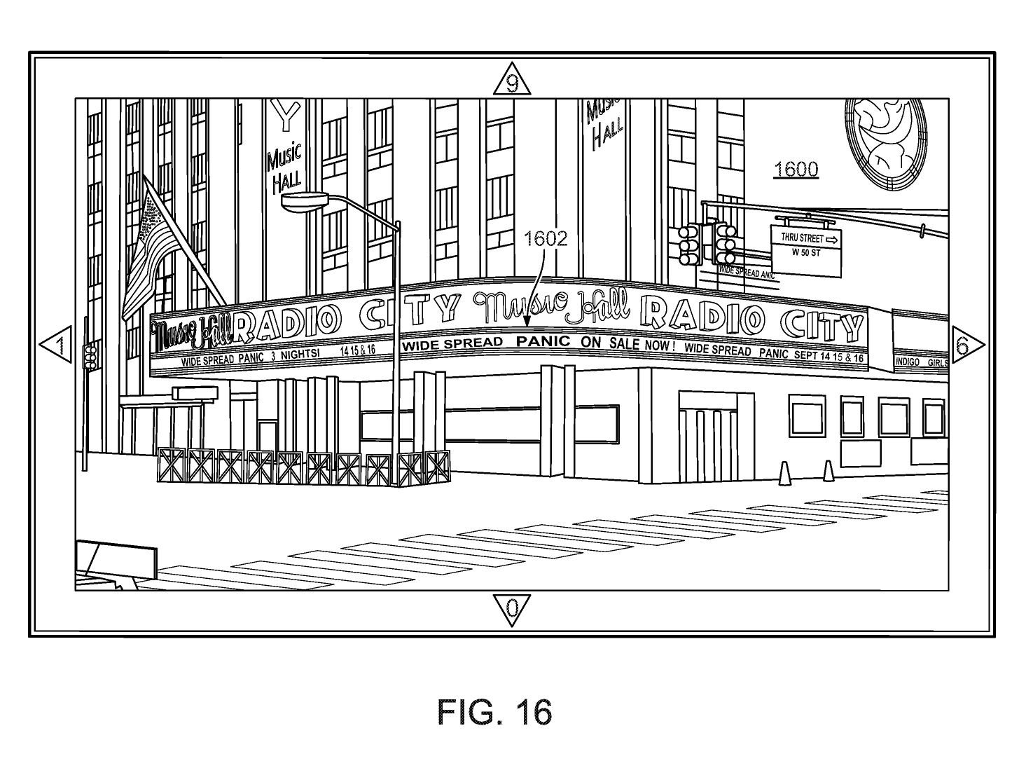

In some embodiments, a music category, theme, or other characteristic building may be presented by control circuitry 304 as part of a 3D environment. Any suitable music category, theme, or other characteristic building may be used in some embodiments. For example, as illustrated in FIG. 16, a music category, theme, or other characteristic building 1600 may be presented as a concert hall, such as Radio City Concert Hall in New York, N.Y.. As shown in FIG. 16, the name(s) 1602 of one or more musical artists may be presented on the front of the building. The musical artist(s) may be artist(s) corresponding to content and/or content listings available for presentation via the media guidance application, and/or may be artists being advertised on the front of the building.

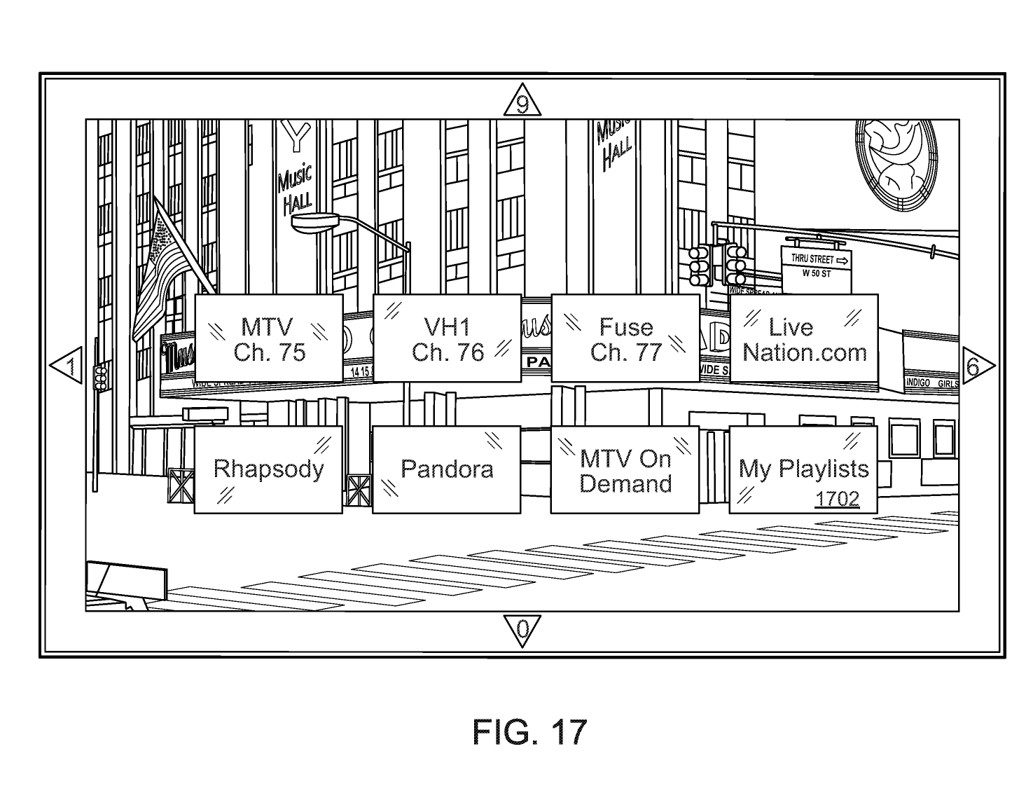

In response to a user selecting the building shown in FIG. 16, control circuitry 304 may present content and/or content listings corresponding to the music category, theme, or other characteristic as shown in FIG. 17. Any suitable content and/or content listings may be presented by the control circuitry in some embodiments. In response to a user selecting one or more of these content listings, the control circuitry may then present more information about the content listing, present the content corresponding to the content listing, set up to record the content corresponding to the content listing, set up a reminder to watch the content listing, and/or perform any other suitable operation as described herein.

For example, in response to a user selecting content listing 1702, the control circuitry may present an interface that allows a user to view his/her playlist(s), edit his/her playlists, import additional playlist(s), export playlist(s) to a device or service, and/or perform any other suitable action.

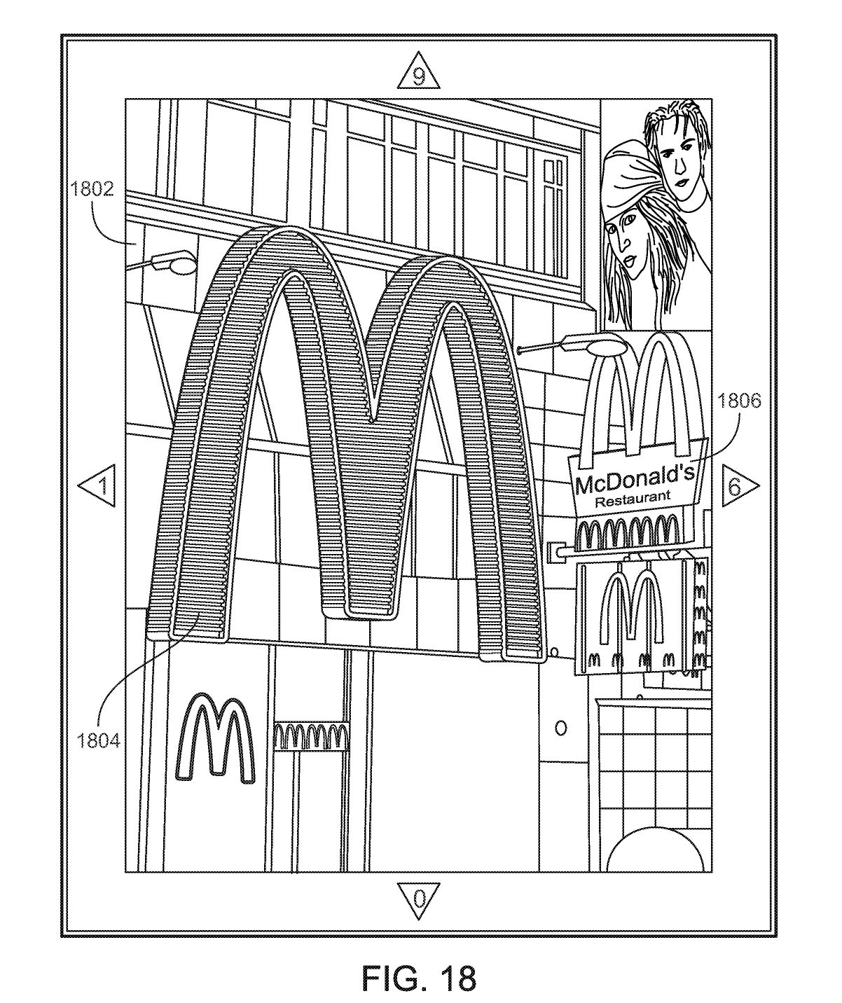

In some embodiments, buildings and/or other structures (such as billboards, signs, etc.) can include advertisements. For example, as shown in FIG. 18, a building 1802 presented by control circuitry 304 in the 3D environment can include a logo 1804 of an advertiser, a name of an advertiser 1806, and/or any suitable trade or service mark of an advertiser.

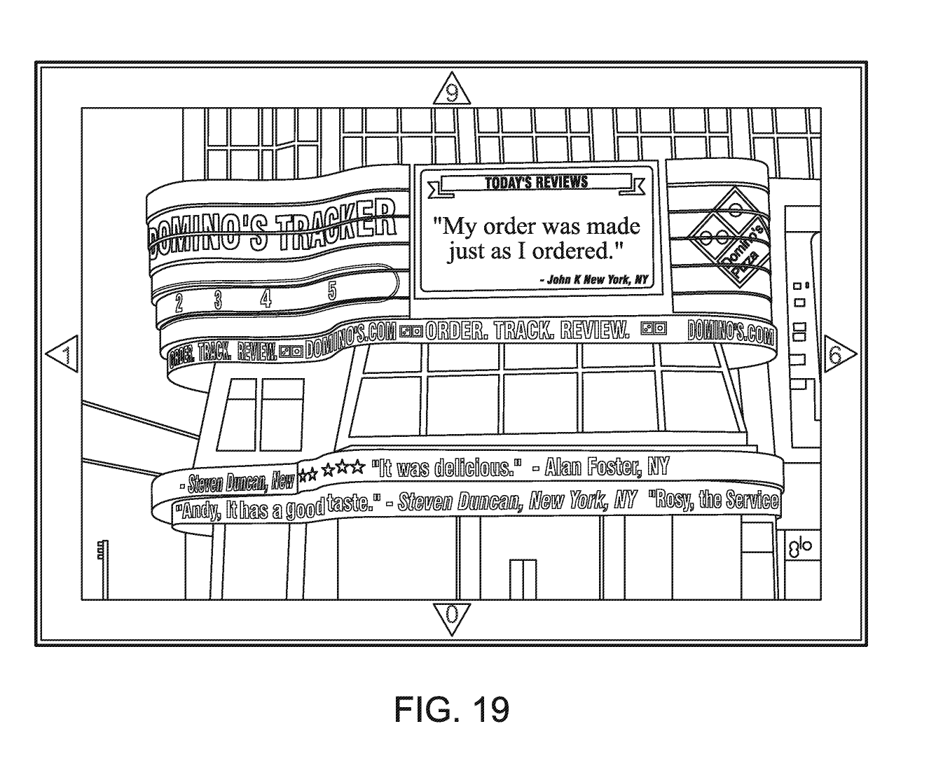

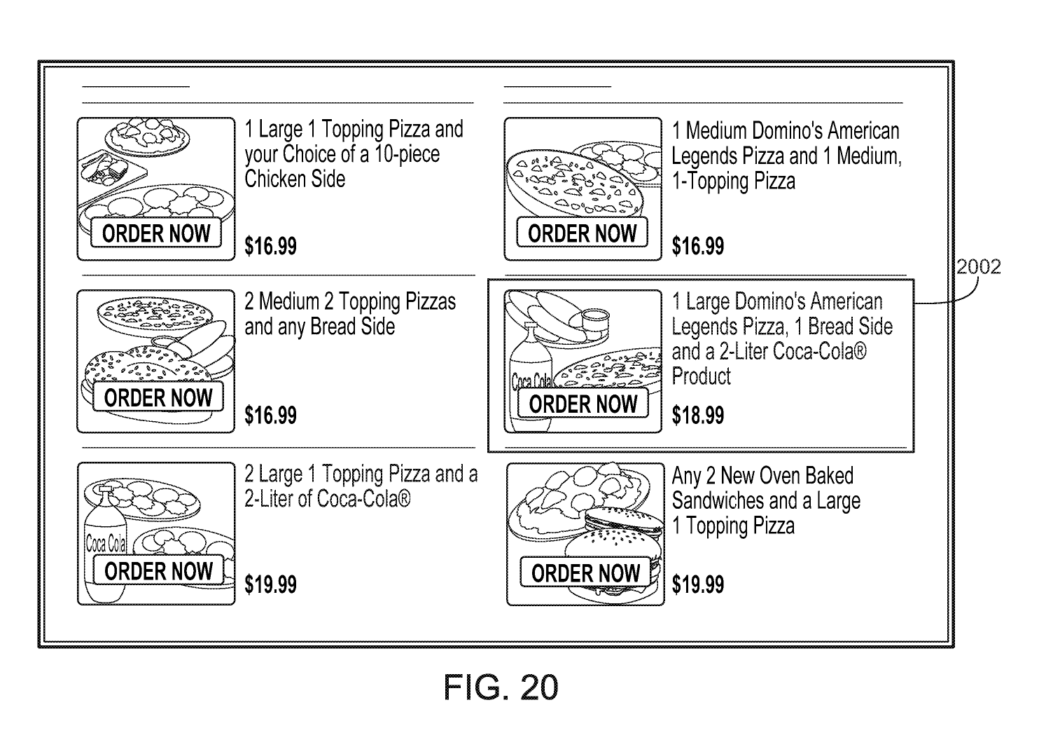

FIG. 19 illustrates another example of a building presenting an advertisement. In the example shown, this advertisement can be for DOMINO'S pizza restaurant. Upon selecting such a restaurant building from the point of view shown in FIG. 19, a menu interface for ordering food from the restaurant can be presented as shown FIG. 20. In some embodiments, in response to a user making a selection of some of the presented food (e.g., by moving a highlight region 2002 to highlight some of the food), control circuitry 304 can transmit to the restaurant an order requesting delivery of the selected food to a service address associated with the user equipment device (which address can be specified in a profile on the device).

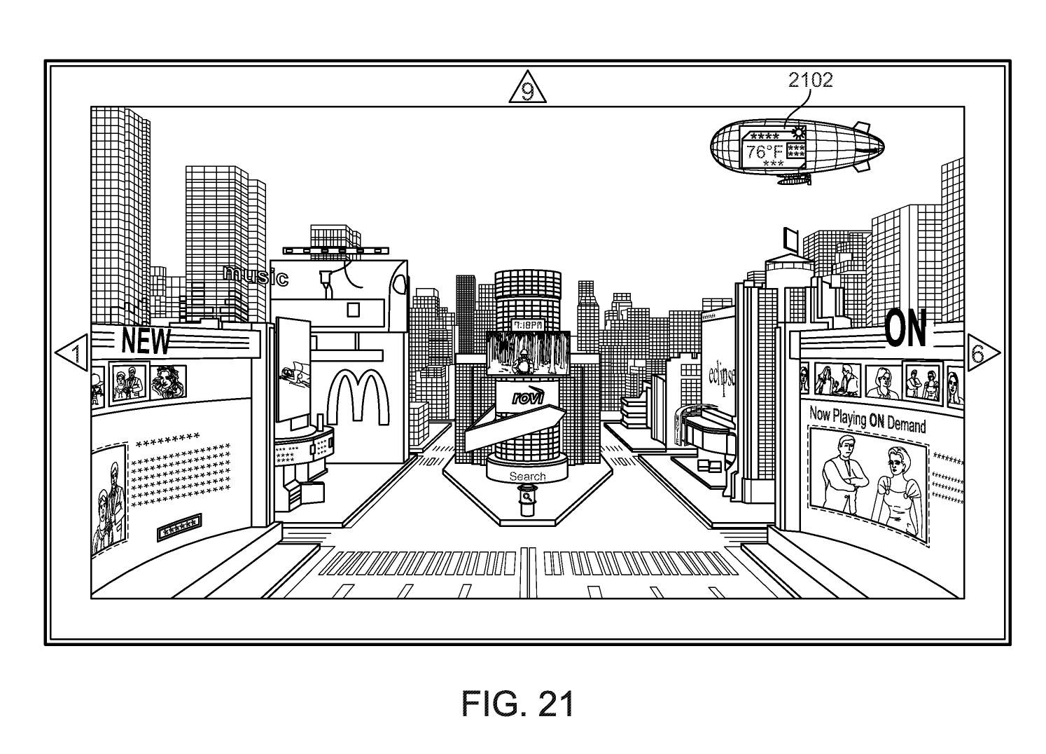

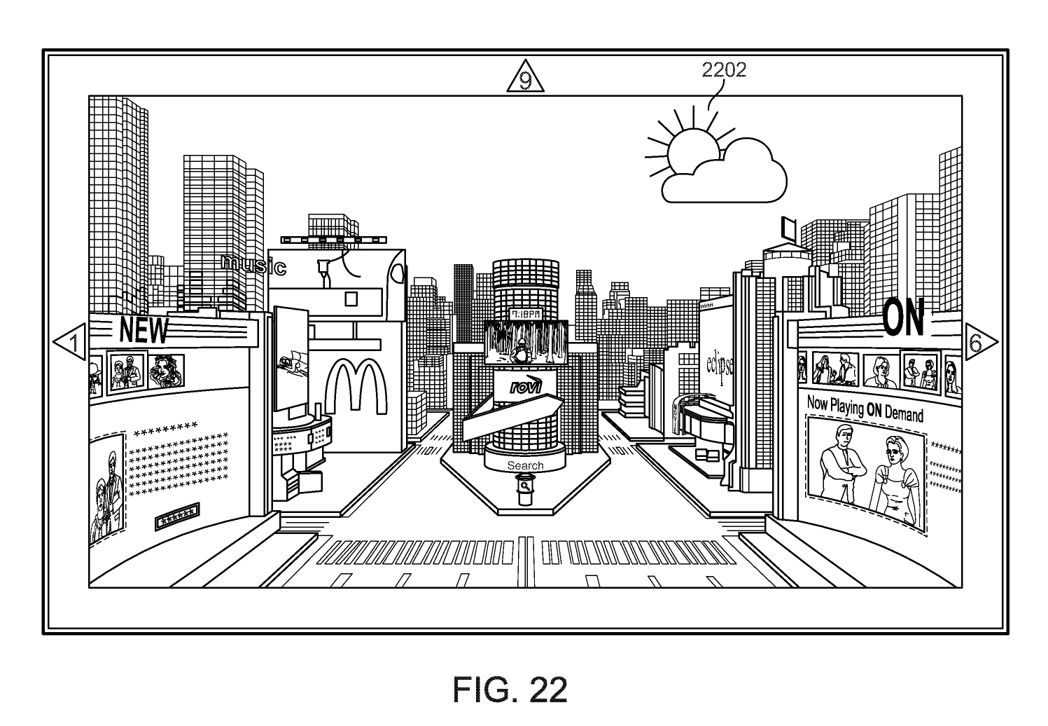

In some embodiments, visual and/or acoustic content can be presented in the 3D environment by the control circuitry 304 to reflect events in the real world. For example, as described above in connection with FIG. 14, stock market data can be presented on the outside of a financial category, theme, or other characteristic building in the 3D environment. This data can be updated in real time to reflect actual stock markets in the real world. As other examples, as shown in FIGS. 21 and 22, content can provide weather information, forecasts, etc. via an suitable mechanism. More particularly, as illustrated in FIG. 21, a blimp or any other suitable aircraft 2102 can be illustrated in the sky of the 3D environment by the control circuitry, and that blimp or aircraft can display weather information, forecasts, etc. reflecting the real conditions in the area in which the user equipment device is located (or any other suitable location configured in user settings, a user profile, or user preferences). As illustrated in FIG. 22, illustrations 2202 of the sun, the moon, clouds, rain, snow, wind, etc. can be presented in the 3D environment by control circuitry 304 to reflect the real conditions in the area in which the user equipment device is located.

In some embodiments, to facilitate the interface in FIG. 20, the content in FIGS. 21 and 22, and any other suitable content in the 3D environment (such as a music player (which can be selectable from the interface of FIG. 17)), user selectable applications may be downloaded onto and installed on the user equipment device and executed by control circuitry 304. Such applications can be downloaded onto the user equipment device from any suitable source, such as an electronic marketplace associated with the user equipment device, a service provider, or any other suitable party (e.g., ITUNES from Apple, Inc.).

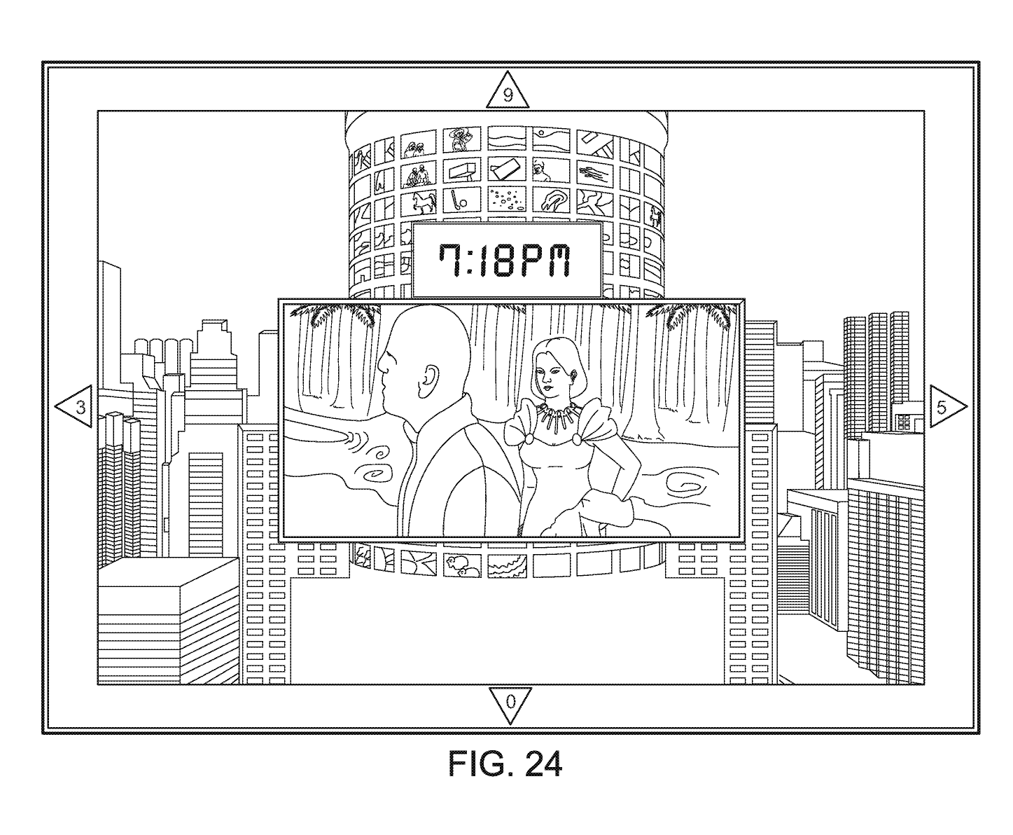

In some embodiments, in response to a user request, the user may be presented by control circuitry 304 with a point of view from point 4 622 (FIG. 6) as shown in FIG. 21. As illustrated, at this point of view, the control circuitry can present a closer view of a video tower building as well as a search icon 2302. In response to a user selection, the control circuitry can present a search window 2304 and a results window 2306. Upon entering a search entry into window 2304, the control circuitry may generate and present search results in 2306. In response to a user highlighting one of the results with a highlight region 2308 (e.g., by using arrow buttons on a user input interface 310), the control circuitry may present a preview of the selected content in window 2310. A more detailed view of window 2310 in accordance with some embodiments is shown in FIG. 24.

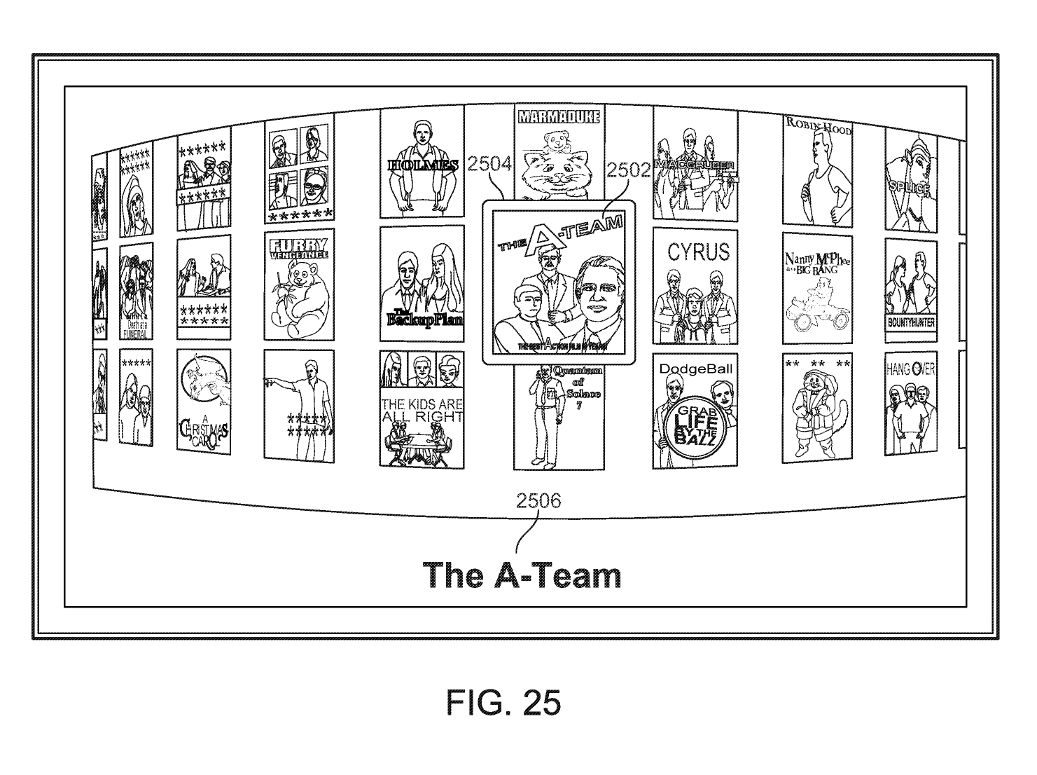

In some embodiments, additionally or alternatively to providing a 3D environment as illustrated in, and described in connection with, FIGS. 6-24, content and/or content listings can be presented by control circuitry 304 as shown in FIG. 25. As illustrated, the content listings can appear to be on the surface of a cylindrical wall. In response to receiving a user selection of left, right, up, or down from a user input interface, the control circuitry can change the presentation of content listings so that they rotate to the left, rotate to the right, shift up, or shift down, respectively. A content listing 2502 at the center of the listings can be enlarged and highlighted by region 2504 to reflect that it is the currently selected listing and to show more detail of the listing. In some embodiments, a name 2506 for the listing 2502 can be presented.

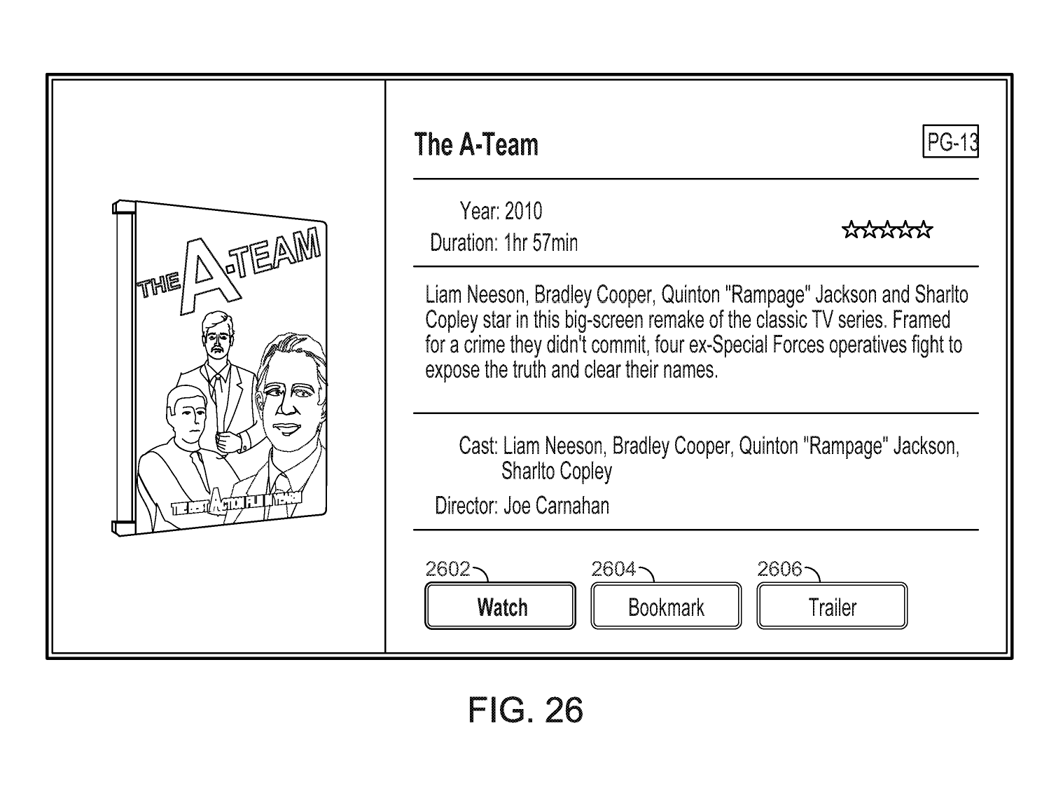

In some embodiments, more information on listing 2502 can be presented by the control circuitry as shown in FIG. 26. Any suitable information can be presented in some embodiments. A user may then be able to select one of buttons 2602, 2604, and 2606 using a user input interface to cause control circuitry to present the content corresponding to the listing, to bookmark the listing, or to present a trailer for the content corresponding to the listing, respectively, or perform any other suitable action, in some embodiments. In some embodiments, the information presented in FIG. 26 can be presented simultaneously with the content listings shown in FIG. 26.

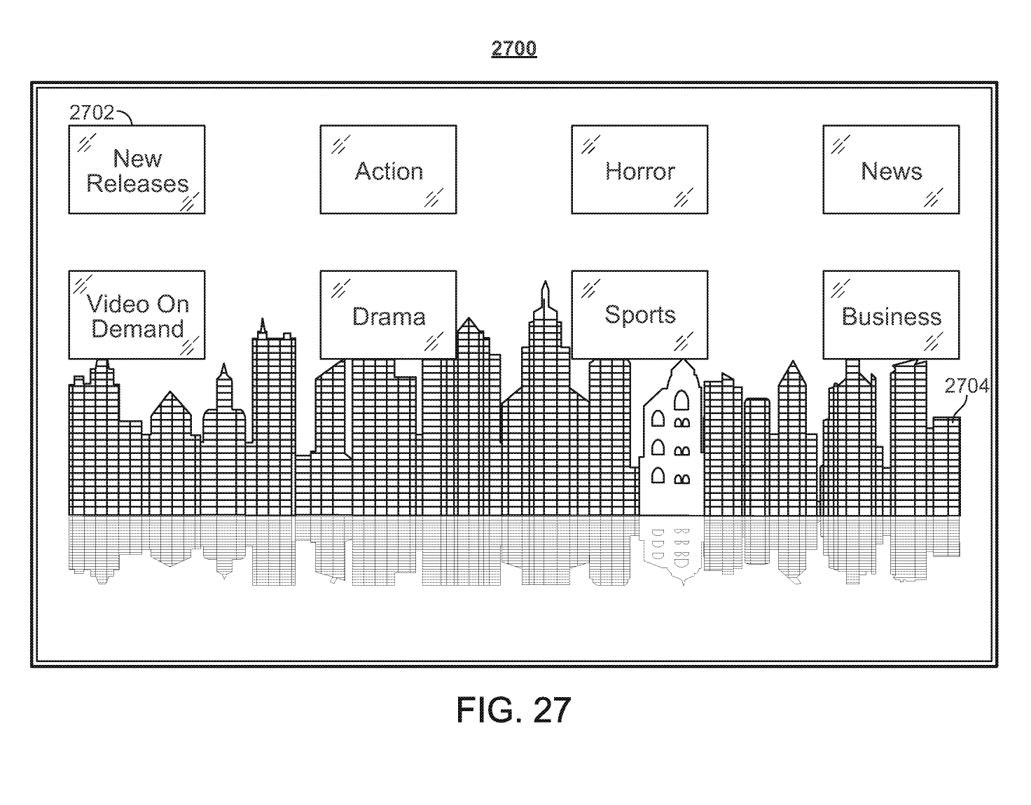

Turning to FIG. 27, as shown, in some embodiments, additionally or alternatively to presenting the interfaces as illustrated in, and described above in connection with, FIGS. 6-26, an interface 2700 in which content listings 2702 are juxtaposed against a cityscape 2704 in the background for a heightened 3D effect can be provided. Although a cityscape is illustrated any suitable background can be presented. As illustrated, content and/or content listings may be presented in panels. These panels may be translucent, in some embodiments.

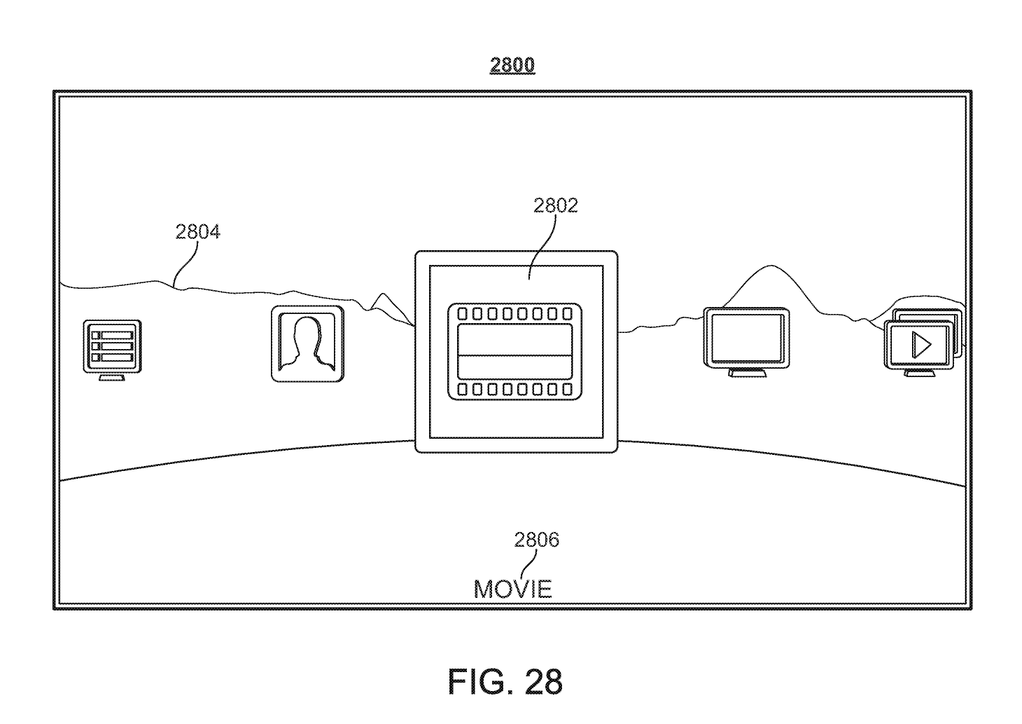

Similarly to FIG. 26, in some embodiments, menu options, content, and/or content listings can be presented by control circuitry 304 as illustrated in interface 2800 of FIG. 28. As shown, icons 2802 (e.g., for menu options as particularly illustrated in FIG. 27) can be presented so as to have a perceived distance in front of a background 2804 (a mountain range as illustrated in FIG. 27, or any other suitable background). In response to user inputs (e.g., left and right inputs), control circuitry 304 may present the icons as rotating on and off the screen. In some embodiments, the icons may be semi-transparent (e.g., alpha level at 15%) in order to induce a 3D effect. In some embodiments, a description 2806 corresponding to an icon in the center of the interface can also be presented.

In some embodiments, the 3D environment interfaces of FIGS. 6-9, 11, and 13-28 can be presented on any suitable user equipment device. For example, in some embodiments, these interfaces can be presented on a stereoscopic three-dimensional display, on a two-dimensional display, on a holographic display, etc.

In some embodiments, any suitable computer readable media may be used for storing instructions for performing the processes described herein. For example, in some embodiments, computer readable media may be transitory or non-transitory. For example, non-transitory computer readable media may include media such as magnetic media (such as hard disks, floppy disks, etc.), optical media (such as compact discs, digital video discs, BLU-RAY discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media may include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

1. A method for presenting a three-dimensional media guidance application, the method comprising:
generating a stereoscopic three-dimensional, virtual environment for presentation on a display, wherein the virtual environment includes representations of a plurality of buildings, and wherein each of the plurality of buildings represents a different characteristic of content and/or content listings;
causing a presentation of the virtual environment from a first point of view to be presented to a user;
receiving user input;
in response to the user input, causing the presentation of the virtual environment to be changed from the first point of view to a second point of view, wherein the rate at which the presentation of the virtual environment is changed is controlled based on a distance between the first point of view and the second point of view;
receiving a user selection of one of the plurality of buildings; and
presenting options associated with the characteristic represented by the building selected by the user.

2. The method of claim 1, wherein the rate at which the presentation of the virtual environment is changed is also controlled based on a rotation between the first point of view and the second point of view.

3. The method of claim 1, wherein the virtual environment includes an advertisement.

4. The method of claim 3, wherein the advertisement is represented as a billboard.

5. The method of claim 3, wherein the advertisement is represented as a store of the advertiser.

6. The method of claim 1, wherein the one of the plurality of buildings selected is a building associated with movies, and wherein the options presented are content and/or content listings associated with movies.

7. The method of claim 1, wherein the virtual environment includes a translucent panel showing video.

8. The method of claim 1, wherein the virtual environment includes an indicator of current weather in an area of the user.

9. The method of claim 1, further comprising changing content presented on a face of one of the plurality of buildings to correspond to a real event.

10. The method of claim 1, further comprising presenting a content listing on a face of one of the plurality of buildings.

11. A system for presenting a three-dimensional media guidance application, the system comprising:
a storage device; and
processing circuitry configured to:
generate a stereoscopic three-dimensional, virtual environment for presentation on a display, wherein the virtual environment includes representations of a plurality of buildings, and wherein each of the plurality of buildings represents a different characteristic of content and/or content listings;
cause a presentation of the virtual environment from a first point of view to be presented to a user;
receive user input;
in response to the user input, cause the presentation of the virtual environment to be changed from the first point of view to a second point of view, wherein the rate at which the presentation of the virtual environment is changed is controlled based on a distance between the first point of view and the second point of view;
receive a user selection of one of the plurality of buildings; and
present options associated with the characteristic represented by the building selected by the user.

12. The system of claim 11, wherein the rate at which the presentation of the virtual environment is changed is also controlled based on a rotation between the first point of view and the second point of view.

13. The system of claim 11, wherein the virtual environment includes an advertisement.

14. The system of claim 13, wherein the advertisement is represented as a billboard.

15. The system of claim 13, wherein the advertisement is represented as a store of the advertiser.

16. The system of claim 11, wherein the one of the plurality of buildings selected is a building associated with movies, and wherein the options presented are content and/or content listings associated with movies.

17. The system of claim 11, wherein the virtual environment includes a translucent panel showing video.

18. The system of claim 11, wherein the virtual environment includes an indicator of current weather in an area of the user.

19. The system of claim 11, wherein the processing circuitry is also configured to change content presented on a face of one of the plurality of buildings to correspond to a real event.

20. The system of claim 11, wherein the processing circuitry is also configured to present a content listing on a face of one of the plurality of buildings.

21-30. (canceled)
